(19) United States
(12) Patent Application Publication
(10) Pub. No.: US 2005/0149441 A1
(43) Pub. Date: Jul. 7, 2005

(54) Personal identification checks

(76) Inventor: Edward L. Maynard, Trenary, MI (US)

Correspondence Address: THE INVENTORS NETWORK, INC., 332 ACADEMY STREET, CARNEGIE, PA, 15106, US

(21) Appl. No.: 10/750,273

(22) Filed: Jan. 2, 2004

(51) Int. Cl. G06F 17/60

(52) U.S. Cl. 705/45; 705/44; 705/39; 705/42

(57) ABSTRACT

A personal identification check is provided that includes a photograph of the owner of the check imprinted on the face of the check for providing visual identification of the owner of the check, and adjacent the photograph are further personal identification substantiation indicia such as the name, address, and telephone number of the owner of the check.

### FIELD OF THE INVENTION

The present invention pertains to personal identification documents, and, more particularly, pertains to the inclusion of photo identification on monetary transaction instruments.

### BACKGROUND OF THE INVENTION

The use of personal checks to transact business and commerce is a fixture of our modern, mobile society. The purchase of any item, product or service offered by contemporary society can be accomplished through the writing and signing of a personal check that is then drawn on the private account of that individual check writer.

However, the use of personal checks as the primary means of effecting commercial transactions is also fraught with opportunities for theft, fraud, misuse and deception. The passing of fraudulent checks is an ongoing problem for retailers ranging from the neighborhood convenience store to the national chains. It is often the case that a check obtained through theft or fraud is passed off to an unsuspecting and harried employee untrained in the detection of such deceptions. As it would be highly unlikely that the dishonest and criminally acting individual would return to the same store, there would be little likelihood that the store employee could accurately recall and identify the physical features of the dishonest individual. Moreover, even if the individual did return within a short time period to the same store to pass more fraudulent checks before the clearance of the initial fraudulent document, his identification would be unlikely given the numbers of customers that pass through convenience stores, retail stores, shopping malls and plazas on a daily basis. The same essential problems of theft, fraud, misuse and deception also accompany the use of traveler's checks, claim checks and boarder passes.

In order to avoid and obviate the above problems, the prior art discloses a number methods and devices for enhancing the secure use of personal checks and other types of personal documents.

The Smithson et al. patent (U.S. Pat. No. 4,865,351) discloses a photo check and a photo application device.

The Johnson et al. patent (U.S. Pat. No. 5,748,755) discloses a personal identification document and a computerized method for adhering a photograph to the document.

The Wilkinson patent (U.S. Pat. No. 5,863,074) discloses a personal check for inhibiting fraud that includes three different types of identification indicia printed on a substrate that is transferable among individuals.

The Leef et al. patent (U.S. Pat. No. 6,106,020) discloses a fraud prevention method and system that includes a personal identification document containing an image thereon.

The Al-Sheikh patent (U.S. Pat. No. 6,137,895) discloses a method in the form of a step-by-step process that includes the steps of image collection and image storage for verifying airline passengers.

Nonetheless, despite the ingenuity of the above-described methods and devices, there remains a need for an improved personal identification check for enhancing security and inhibiting fraud.

### SUMMARY OF THE INVENTION

The present invention comprehends a document or instrument that includes a visual identification of the owner and is generally a blank negotiable check having a digitally produced photograph of the individual owner of the check in the upper left hand corner thereof. Immediately adjacent and to the right of the photograph are indicia indicating the name, address and telephone number of the owner of the check.

It is an objective of the present invention to provide a personal identification check that includes a digitally produced image of the owner affixed to the check.

It is another objective of the present invention to provide a personal identification check that expedites the movement of the individual through any checkout line by having a picture of the individual on the document, such as the personal identification check.

It is yet another objective of the present invention to provide a personal identification check that increases the security of the document by having a picture of the owner of the check affixed thereto thus inhibiting the unauthorized use of the check.

Yet another objective of the present invention is to provide a personal identification check that has the owner's picture affixed thereto in order to avoid searches through other clothing articles, such as pockets, purses and wallets, to find corroborating photographic identification.

These and other objects, features, and advantages will become apparent to one skilled in the art upon a perusal of the following detailed description read in conjunction with the accompanying drawings.

### BRIEF DESCRIPTION OF THE DRAWINGS

FIG. 1 is a front elevational view of a personal check having a section delimited in the upper left hand corner for receiving thereon a photographic image; and

FIG. 2 is a front elevational view of a personal check including the photographic image of the owner of the check and accompanying identifying indicia such as name, address and telephone number.

### DETAILED DESCRIPTION OF THE PREFERRED EMBODIMENT

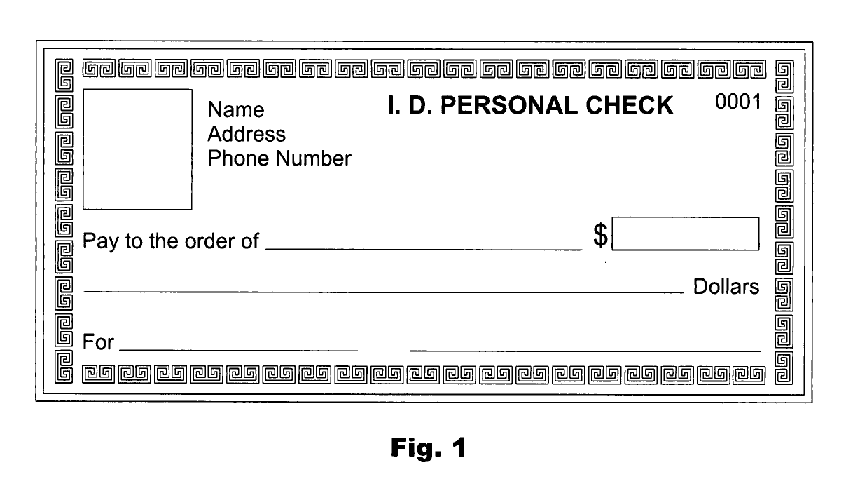

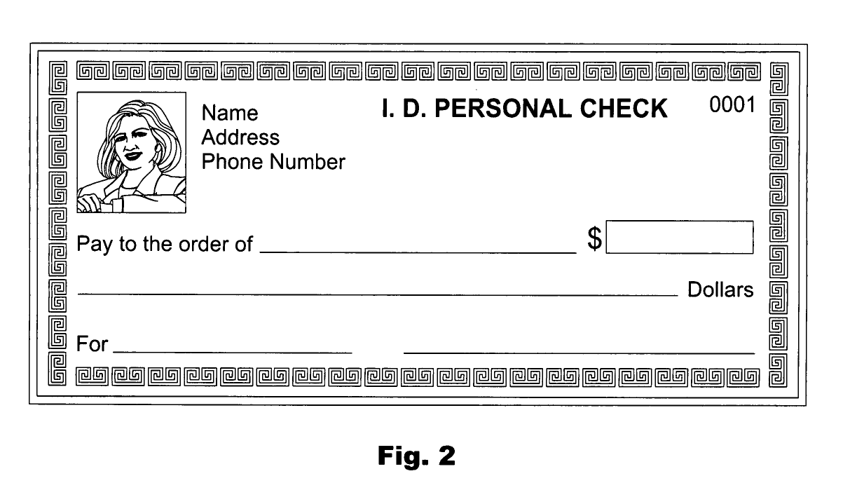

Illustrated in FIGS. 1 and 2 is a document or instrument 10 containing personal identification data, and in the preferred embodiment of the invention the instrument 10 is a personal identification check 12 issued by a financial institution, such as a bank, to the owner and individual authorized to use the check 12. The personal identification check 12 includes a front surface 14 and an opposite rear surface 16. Displayed on the front surface 14 are various standard indicia such as the check number 18, the payee line 20 and the transaction amount line 22 and box 24.

As an enhancement for the safety and security of the owner of the personal check 12, the front surface 14 of the check 12 includes, in the upper left hand region or section 26, an area delimited for receiving or having affixed thereto a photographic image 28 of the authorized owner and user of the check 12. FIG. 1 illustrates the defined region 26 on the front surface 12 without the photographic image 28 affixed thereto; the photographic image 28 is illustrated in FIG. 2. In addition, immediately adjacent to the photographic image 28 are further informational indicia, unique for that owner, in the form of the individual's name 30, address 32, and phone number 34 imprinted thereon. These informational indicia further corroborate the identity of the individual.

The personal identification check 12 of the present invention can be created in a number of ways utilizing computers, laser printers and scanners and digital imaging technology. One manner of creating the photographic image 28 of the respective owner of the check 12 and then transferring the image 28 to the ordered or requested personal identification checks 12 is for an employee at a financial institution, normally a bank, to first photograph the prospective account owner. The photographic image 28 can be stored on, for example, a mini disc, such as is used in digital cameras, and then transferred at the appropriate time for printing on the checks 12 thus creating the personal identification checks 12 of the present invention.

The foregoing description discloses and describes a preferred embodiment for the present invention, and those skilled in the art will understand that other variations and modifications may be possible and practicable and still come within the scope of the appended claims.

1. An instrument for effecting monetary transactions for the authorized owner of the instrument, comprising:
a personal check having a front surface and an opposite rear surface;
the front surface including lines and informational indicia;
a photographic image of the owner of the instrument affixed to the upper left hand region of the front surface; and
identifying indicia immediately adjacent and to the right of the photographic image.

2. A method of imprinting the photographic image of the authorized owner on a set of personal checks comprising the steps of:
having the owner of the checks appear at a financial institution;
photographing the owner of the checks by an employee of the financial institution;
digitally transferring the photographic image of the owner onto the checks during the check printing process; and
presenting the checks to the authorized owner with the photographic image of the authorized owner affixed at the upper left hand section of the checks.
